(19) United States
(12) Patent Application Publication
(10) Pub. No.: US 2012/0008790 A1
(43) Pub. Date: Jan. 12, 2012

(54) METHOD FOR LOCALIZING AN AUDIO SOURCE, AND MULTICHANNEL HEARING SYSTEM

(75) Inventor: Vaclav Bouse, Erlangen (DE)

(73) Assignee: SIEMENS MEDICAL INSTRUMENTS PTE. LTD., Singapore (SG)

(21) Appl. No.: 13/177,632

(22) Filed: Jul. 7, 2011

(30) Foreign Application Priority Data
Jul. 7, 2010 (DE) 10 2010 026 381.8

(51) Int. Cl. H04R 25/00

(52) U.S. Cl. 381/23.1

(57) ABSTRACT

Sound sources are reliably localized using a multichannel hearing system, in particular a binaural hearing system. The method localizes at least one audio source by detecting a signal in a prescribed class, the signal stemming from the audio source, in an input signal in the multichannel hearing system. The audio source is then localized using the detected signal. First, the nature of the signal is established over a wide band and then the location of the source is determined.

### CROSS-REFERENCE TO RELATED APPLICATION

This application claims the priority, under 35 U.S.C. §119, of German patent application DE 10 2010 026 381.8, filed Jul. 7, 2011; the prior application is herewith incorporated by reference in its entirety.

### BACKGROUND OF THE INVENTION

### Field of the Invention

The present invention relates to a method for localizing at least one audio source using a multichannel hearing system. Furthermore, the present invention relates to an appropriate multichannel hearing system having a plurality of input channels and particularly also to a binaural hearing system. In this context, a “binaural hearing system” is understood to mean a system which can be used to supply sound to both ears of a user. In particular, it is understood to mean a binaural hearing aid system in which the user wears a hearing aid on both ears and the hearing aid supplies the respective ear.

Hearing aids are portable hearing apparatuses which are used to look after people with impaired hearing. In order to meet the numerous individual needs, different designs of hearing aids are provided, such as behind the ear hearing aids (BTE), hearing aids with an external receiver (RIC: receiver in the canal) and in the ear hearing aid (ITE), for example including concha hearing aids or channel hearing aids (ITE, CIC—completely in the canal). The hearing aids listed by way of example are worn on the outer ear or in the auditory canal. Furthermore, there are also bone conduction hearing aids, implantable or vibrotactile hearing aids available on the market, these involve the damaged hearing being stimulated either mechanically or electrically.

Hearing aids include the primarily important components input transducer, amplifier and output transducer. The input transducer is usually a sound receiver, e.g. a microphone, and/or an electromagnetic receiver, e.g. an induction coil. The output transducer is usually in the form of an electroaccoustic transducer, e.g. a miniature loudspeaker, or in the form of an electromechanical transducer, e.g. a bone conduction receiver. The amplifier is usually integrated in a single processing unit.

This basic design is illustrated in FIG. 1 using the example of a behind the ear hearing aid. A hearing aid housing 1 to be worn behind the ear incorporates one or more microphones 2 for picking up the sound from the surroundings. A signal processing unit (SPU) 3, which is likewise integrated in the hearing aid housing 1, processes the microphone signals and amplifies them. The output signal from the signal processing unit 3 is transmitted to a loudspeaker or receiver 4 which outputs an acoustic signal. The sound is possibly transmitted to the eardrum of the appliance wearer via a sound tube which is fixed to an earmold in the auditory canal. Power is supplied to the hearing aid and particularly to the signal processing unit 3 by a battery (BAT) 5, which is likewise integrated in the hearing aid housing 1.

Generally, the object of a computer-aided scene analysis system (CASA: Computational Auditory Scene Analysis system) is to describe an acoustic scene by means of spatial localization and classification of the acoustic sources and preferably also the acoustic environment. For the purpose of illustration, the example of the “cocktail party problem” is presented in this case. A large number of speakers in conversation are producing background voice sounds, two people are conversing close to the observer (directional sound), some music is coming from another direction and the room acoustics are somewhat dead. Similar to human hearing being capable of localizing and distinguishing the different audio sources, a CASA system attempts to imitate this function in a similar manner, so that it can localize and classify (e.g. voice, music, noise etc.) at least each source from the mix of sounds. Information in this regard is valuable not only for hearing aid program selection but also for what is known as a beamformer (spatial filter), for example, which can be deflected into the desired direction in order to amplify the desired signal for a hearing aid wearer.

An ordinary CASA system operates such that the audio signal is transformed into the time-frequency domain (T-F) by Fourier transformation or by similar transformation, such as wavelets, gamma-tone filter bank, etc. In this case, the signal is thus converted into a multiplicity of short-term spectra.

FIG. 2 shows a block diagram of a conventional CASA system of this kind. The signals from a microphone 10 in a left-ear hearing aid and from a microphone 11 in a right-ear hearing aid are supplied together to a filter bank 12 which performs the transformation into the T-F domain. The signal in the T-F domain is then segmented into separate T-F blocks in a segmentation unit 13. The T-F blocks are short-term spectra, with the blocks usually starting after what is known as “T-F onset detection,” that is say when the spectrum of a signal exceeds a certain level. The length of the blocks is determined by analyzing other features. These features typically include an offset and/or coherency. A feature extraction unit 14 is therefore provided which extracts features from the signal in the T-F domain. By way of example, such features are an interaural time difference (ITD), an interaural level difference (ILD), a block cross-correlation, a fundamental frequency, and the like. Each source can be localized 15 using the estimated or extracted features (ITD, ILD). The extracted features from the extraction unit 14 can alternatively be used to control the segmentation unit 13.

The relatively small blocks obtained downstream of the segmentation unit 13 are reassembled in a grouping unit 16 in order to represent the different sources. To this end, the extracted features from the extraction unit 14 are subjected to feature analysis 17, the analysis results of which are used for the grouping. The thus grouped blocks are supplied to a classification unit 18, which is intended to be used to recognize the type of the source which is producing the signal in a block group. The result of this classification and the features of the analysis 17 are used to describe a scene 19.

The description of an acoustic scene in this manner is frequently prone to error, however. In particular, it is not easy to precisely separate and describe a plurality of sources from one direction, because the small T-F blocks contain only little information.

### SUMMARY OF THE INVENTION

It is accordingly an object of the invention to provide a method for localizing an audio source and a multi-channel hearing system which overcome the above-mentioned disadvantages of the heretofore-known devices and methods of this general type and which improve the detection and localization of acoustic sources in a multichannel hearing system.

With the foregoing and other objects in view there is provided, in accordance with the invention, a method of localizing an audio source (i.e., one or more audio sources) using a multichannel hearing system. The method comprises:

acquiring an input signal in the multichannel hearing system;

detecting a signal in a prescribed class, the signal originating from the audio source, in the input signal; and

subsequently localizing the audio source using the signal detected in the detecting step.

In other words, the invention achieves the objects by way of a method for localizing at least one audio source using a multichannel hearing system by detecting a signal in a prescribed class, which signal stems from the audio source, in an input signal in the multichannel hearing system and subsequently localizing the audio source using the detected signal.

Furthermore, the invention provides a multichannel hearing system having a plurality of input channels, comprising a detection device for detecting a signal in a prescribed class, which signal stems from an audio source, in an input signal in the multichannel hearing system, and a localization device for localizing the audio source using the detected signal.

Advantageously, the localization is preceded by the performance of detection or classification of known signal components. This allows signal components to be systematically combined on the basis of their content before localization takes place. The combination of signal components results in an increased volume of information for a particular source which means that the localization thereof can be performed more reliably.

Preferably, the detection involves prescribed features of the input signal being examined, and the presence of the prescribed features at an intensity which is prescribed for the class prompts the signal in the prescribed class to be deemed to have been detected in a particular time window in the input signal. Detection thus takes place using a classification.

The prescribed features may be harmonic signal components or the manifestation of formants. This allows characteristic features, in particular, to be obtained using the signal class “voice,” for example.

In one specific embodiment, a plurality of signals in the prescribed class are detected in the input signal and are associated with different audio sources on the basis of predefined criteria. This means that, by way of example, it is also possible for different speakers to be separated from one another, for example on the basis of the fundamental frequency of the voiced sounds.

In accordance with one development of the present invention, the localization on the basis of the detected signal is preceded by signal components being filtered from the input signal. The detection stage is thus used in order to increase the useful signal component for the source that is to be localized. Interfering signal components are thus filtered out or rejected.

An audio source can be localized by known localization algorithms and subsequent cumulative statistics. This means that is possible to resort to known methods for localization.

The localization usually requires signals to be interchanged between the appliances in a binaural hearing system. Since relevant signals have now been detected beforehand, the localization now requires only the transmission of detected and possibly filtered signal components of the input signal between the individual appliances in the binaural hearing system. Signal components which have not been detected for a specific class or which have not been classified are thus not transmitted, which means that the volume of data to be transmitted is significantly reduced.

Other features which are considered as characteristic for the invention are set forth in the appended claims.

Although the invention is illustrated and described herein as embodied in a method for localizing an audio source, and multichannel hearing system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a basic diagram of a hearing aid based on the prior art;

FIG. 2 is a block diagram of a prior art scene analysis system;

FIG. 3 is a block diagram of a system according to the invention; and

FIG. 4 is a signal graph plotting various signals in the system of FIG. 3 for two separate sound sources.

### DETAILED DESCRIPTION OF THE INVENTION

The fundamental concept of the present invention is that of detecting and filtering portions of an input signal in a multichannel, in particular binaural hearing system in a first step and localizing a corresponding source in a second step. The detection involves particular features being extracted from the input signal, so that classification can be performed.

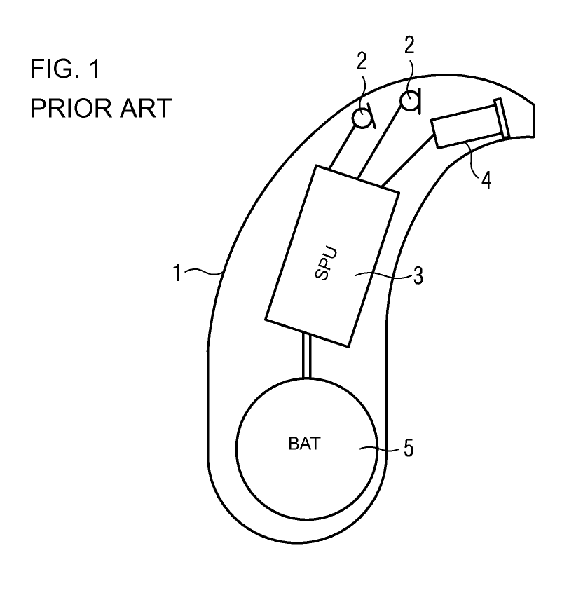

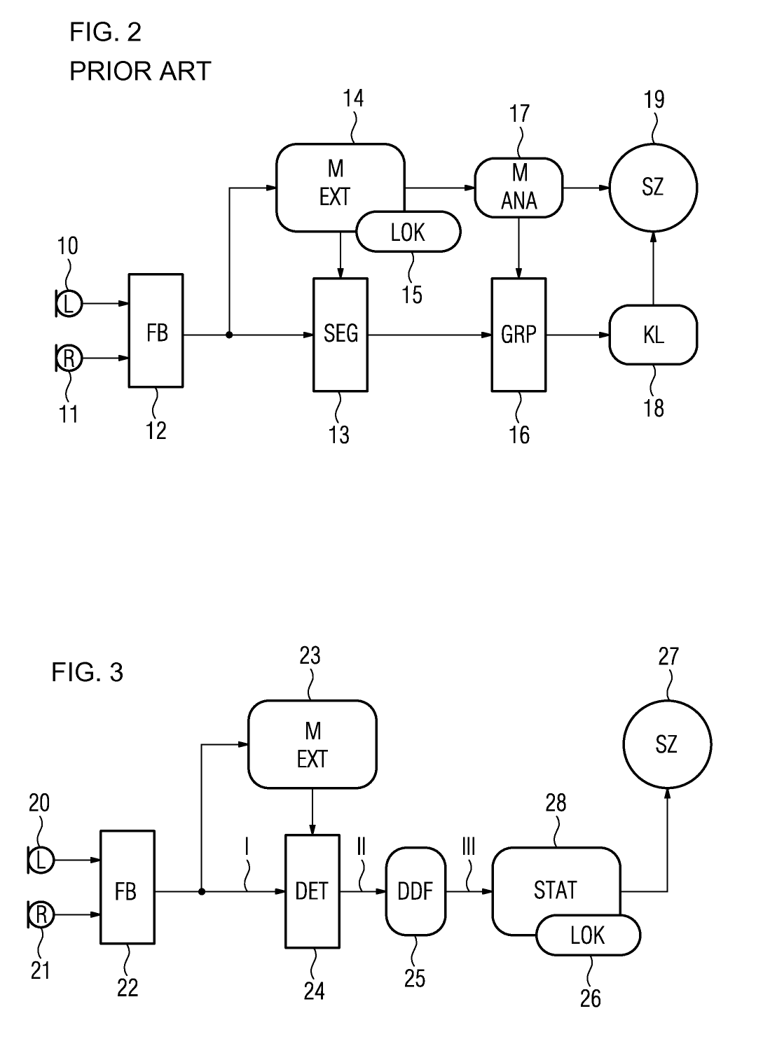

Referring now once more to the figures of the drawing in detail, a block diagram of a hearing system (in this case binaural) according to the invention is illustrated in FIG. 3. The illustration includes on only those components which are primarily important to the invention. The further components of a binaural hearing system can be seen from FIG. 1 and the description thereof, for example. The binaural hearing system according to the example in FIG. 3 comprises a microphone 20 in a left appliance, particularly a hearing aid, and a further microphone 21 in a right (hearing) appliance. Alternatively, another multichannel hearing system having a plurality of input channels can also be chosen, e.g. a single hearing aid having a plurality of microphones. The two microphone signals are transformed into the time-frequency domain (T-F) by a filter bank 22 as in the example in FIG. 2, so that appropriate short-term spectra of a binaural overall signal are obtained. However, such a filter bank 22 can also be used to transform the input signal into another representation.

The output signal from the filter bank 22 is supplied to a feature extraction unit 23. The function of the feature extraction unit 23 is that of estimating the features which can be used for reliable (model-based) detection and explicit distinction between signal classes. By way of example, such features are harmonicity (intensity of harmonic signal components), starting characteristics of signal components, fundamental frequency of voiced sounds (pitch), and naturally also a selection of several such features.

On the basis of the extracted features in the extraction unit 23, a detection unit 24 attempts to detect and extract (isolate) known signal components from the signal in the filter bank 22 in the T-F domain, for example. If it is desired that the direction of one or more speakers be estimated, for example, the signal components sought may be vowels. In order to detect vowels, the system can look for signal components with high harmonicity (that is to say pronounced harmonics) and a specific formant structure. However, vowel detection is an heuristic and uncertain approach, and a universal CASA system needs to be capable of also detecting classes other than voice. It is therefore necessary to use a more theoretical approach on the basis of monitored learning and the most optimum feature extraction possible.

The overriding object of this detection block 24 is not to detect every occurrence of the particular signal components but rather to recognize only those components which can be detected reliably. If some blocks cannot be associated by the system, it is still possible to associate others. Incorrect detection of a signal, on the other hand, reduces the validity and the strength of the information of the subsequent signal blocks.

In a subsequent step of an algorithm according to the invention, decision directed filtering (DDF) 25 takes place. The detected signal is filtered out of the signal mix in order to increase the productivity of the subsequent processing blocks (in this case localization). By way of example, it is again possible to consider the detection of vowels in a voice signal. When a vowel is detected, its estimated formant structure, for example, can be used to filter out undesirable interference which is recorded outside of the formant structure.

In a final step of the algorithm, a freely selectable localization method 26 is performed on the basis of the extracted signal components from the filter 25. The position of the signal source together with the appropriate class is then used to describe the acoustic scene 27. By way of example, the localization can be performed by means of simple cumulative statistics 28 or by using highly developed approaches, such as tracking each source in the space around the receiver.

The most significant advantage of the method according to the invention in comparison with other algorithms is that the problem of the grouping of particular T-F values or blocks (similar to the known problem of blind source separation) does not need to be solved. Even if the systems known from the prior art frequently differ (number of features and different grouping approaches), all of these systems have essentially the same restrictions. As soon as the T-F blocks have been isolated from one another by a fixed decision rule, they need to be grouped again. The information in the individual small blocks is normally not sufficient for grouping in real scenarios, however. In contrast, the approach according to the invention allows single source localization with a high level of precision on account of the use of the entire frequency range (not just single frequencies or single frequency bands).

A further notable property of the proposed system is the ability to detect and localize even multiple sources in the same direction when they belong to different classes. By way of example, a music source and a voice source having the same DOA (direction of arrival) can be identified correctly as two signals in two classes.

Furthermore, the system according to the invention can be extended using a speaker identification block, so that it becomes possible to track a desired signal. By way of example, the practical benefit could be that a desired source (for example a dominant speaker or a voice source chosen by the hearing aid wearer) is localized and identified. In that case, when the source is moving in the room, the hearing aid system automatically tracks its position and can deflect a beamformer into the new direction, for example.

The algorithm according to the invention may also be able to reduce a data rate between a left and a right hearing aid (wireless link). The reason is that if the localization involves only the detected components (or even just the representatives thereof) of the left and right signals being transmitted between the hearing aids, it is necessary to transmit significantly fewer data items than in the case of complete signal transmission.

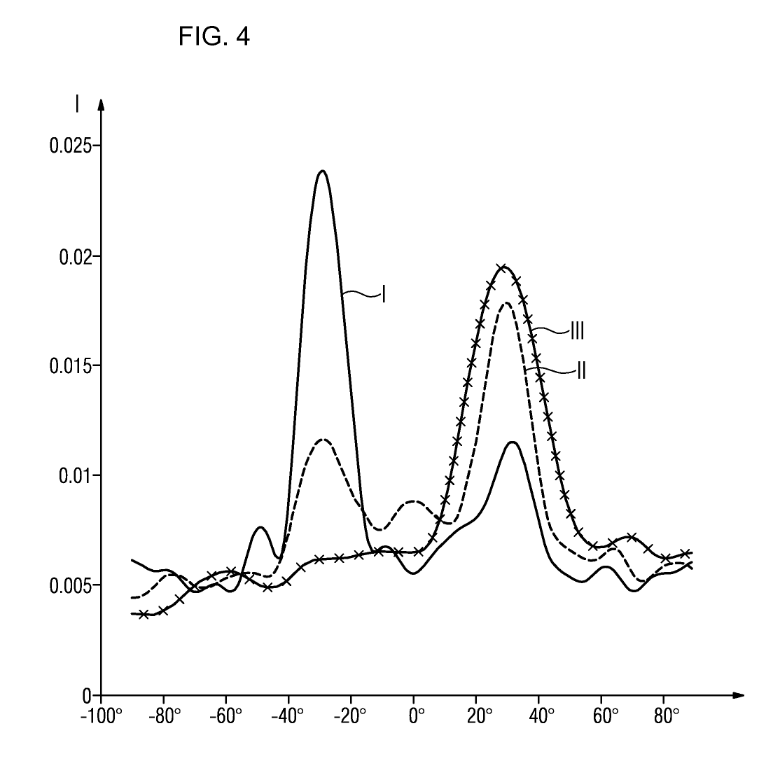

The algorithm according to the invention allows the localization of simultaneous acoustic sources with a high level of spatial resolution together with classification thereof. To illustrate the efficiency of this new approach, FIG. 4 shows localization of vowels in a complex acoustic scene. The scene involves a voice source being present in a direction of φ=30° and having a power P=−25 dB. A music source is at φ=−30° and has a power P=−25 dB. Furthermore, diffusive voice sounds at a power of P=−27 dB and Gaussian noise at a power of P=−70 dB are present. In the graph in FIG. 4, in which the intensity or power is plotted upwards and the angle in degrees is plotted to the right, two primary signal humps can be determined which represent the two signal sources (voice source and a music source). Curve I shows the input signal in the entire frequency spectrum downstream of the filter bank 22 (cf. FIG. 3). The signal has not yet been processed further at this point. Curve II shows the signal after detection of vowels by the detection unit 24 (cf. FIG. 3). Finally, curve III represents the localization result downstream of the filter unit 25 (cf. also FIG. 3), with a known ideal formant mask being used. On the basis of curve III, it is thus possible to explicitly localize the voice source.

The algorithm according to the invention can be modified. Thus, by way of example, a signal or the source thereof is not just able to be localized and classified, but rather relevant information can also be fed back to the classification detector 24, so that the localization result can be iteratively improved. Alternatively, the feedback can be used to track a source. Furthermore, this approach can be used to determine a head turn. In this case, the system can be used on its own or as part of a physical head movement detection system with accelerometers.

A further modification to the system may involve the use of an estimated direction (DOA) for a desired signal for controlling a beamformer upstream of a detector in order to improve the efficiency of an overall system.

The example cited above relates to the localization of a voice source. The proposed system can also detect other classes of signals, however. In order to detect and classify different signals, it is necessary to use different features and possibly different representatives of the signals. If detection of a music signal is desired, for example, then the system needs to be trained with different musical instruments, and a suitable detector needs to be used.

The principle of the system according to the invention is implemented primarily as an algorithm for hearing aids. Use is not limited to hearing aids, however. On the contrary, such a method can also be used for navigation systems for blind people, for example in order to localize specific sounds in public places or, in yet another application, in order to find faulty parts in a large machine acoustically.

1. A method of localizing an audio source using a multichannel hearing system, the method which comprises:
acquiring an input signal in the multichannel hearing system;
detecting a signal in a prescribed class, the signal originating from the audio source, in the input signal; and
subsequently localizing the audio source using the signal detected in the detecting step.

2. The method according to claim 1, wherein the detecting step comprises examining prescribed features of the input signal, and wherein, if the prescribed features are present at an intensity that is predetermined for the prescribed class, the signal in the prescribed class is deemed to have been detected in the input signal.

3. The method according to claim 2, wherein the prescribed features are harmonic signal components or formants.

4. The method according to claim 3, wherein the prescribed class is “voice”.

5. The method according to claim 1, which comprises detecting a plurality of signals in the prescribed class in the input signal and associating the plurality of signals with different audio sources on a basis of predefined criteria.

6. The method according to claim 5, wherein the different audio sources are a plurality of speakers.

7. The method according to claim 1, which comprises filtering signal components from the input signal prior to localizing on the basis of the detected signal.

8. The method according to claim 1, wherein the localizing step comprises carrying out cumulative statistics using a localization algorithm.

9. The method according to claim 1, wherein the multichannel hearing system is a binaural hearing system having two individual appliances, and the localizing step comprises transmitting only detected signal components of the input signal between the individual appliances in the binaural hearing system.

10. A multichannel hearing system with a plurality of input channels, the system comprising:
a detection device for detecting a signal in a prescribed class, which signal stems from an audio source, in an input signal of the multichannel hearing system; and
a localization device connected to said detection device for localizing the audio source using the signal detected with said detection device.
